(19) United States
(12) Patent Application Publication
(10) Pub. No.: US 2025/0081156 A1
(43) Pub. Date: Mar. 6, 2025

(54) METHOD AND APPARATUS FOR SUPPORTING ULTRA WIDEBAND POSITIONING IN WIRELESS COMMUNICATION SYSTEM

(71) Applicant: Samsung Electronics Co., Ltd., Gyeonggi-do (KR)

(72) Inventors: Cheolkyu SHIN, Gyeonggi-do (KR); Jonghoe KOO, Gyeonggi-do (KR); Hyunsuk RYU, Gyeonggi-do (KR); Jonghyo LEE, Gyeonggi-do (KR)

(21) Appl. No.: 18/819,478

(22) Filed: Aug. 29, 2024

(30) Foreign Application Priority Data
Aug. 29, 2023 (KR) 10-2023-0113488

(51) Int. Cl. H04W 64/00; H04W 88/06

(52) U.S. Cl. CPC H04W 64/003; H04W 88/06

(57) ABSTRACT

The disclosure relates to a 5G or 6G communication system for supporting a higher data transmission rate. A method performed by a first UE in a wireless communication system includes receiving, from an LMF, assistance data including a UWB anchor list, receiving, from a plurality of UWB anchors, a plurality of UWB messages including UWB measurements, determining location information of the first UE based on the plurality of UWB messages, and transmitting, to the LMF, the determined location information.

### CROSS REFERENCE TO RELATED APPLICATION

The present application claims priority under 35 U.S.C. § 119 to Korean Patent Application No. 10-2023-0113488, filed on Aug. 29, 2023, in the Korean Intellectual Property Office, the entire content of which is incorporated herein by reference.

### BACKGROUND

### 1. Field

The disclosure relates generally to a wireless communication system, and more particularly, to a method and apparatus for supporting ultra-wideband (UWB) positioning as a radio access technology (RAT)-independent positioning scheme in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying 2-step random access channel (2-step RACH) procedures for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In a 5G system, a network data collection and analysis function (NWDAF), which is a network function that provides a function of analyzing data collected from a 5G network and providing an analysis result, may be defined to support network automation. The NWDAF may collect/store/analyze information from 5G networks and provide the results to unspecific network functions (NFs), and the analysis results may be used independently by each NF.

To meet the demand for wireless data traffic having increased since commercialization of 4G communication systems, efforts have been made to improve 5G NR systems. To achieve a high data transmission rate, the 5G communication systems have been designed to enable resources in mm Wave bands. To mitigate path loss of radio waves and increase a propagation distance of radio waves in an ultra-high frequency band, beamforming, massive MIMO, FD-MIMO, array antenna, analog beamforming, and large scale antenna technologies have been discussed in 5G communication systems. Further, unlike LTE, 5G communication systems support various subcarrier spacings such as 30 kHz, 60 kHz, and 120 kHz, including 15 kHz, a physical control channel uses polar coding, and a physical data channel uses an LDPC. In addition, cyclic prefix-orthogonal frequency division multiplexing (CP-OFDM) as well as discrete Fourier transform-spread-orthogonal frequency division multiplexing (DFT-S-OFDM) is used as a waveform for UL transmission. In LTE, hybrid ARQ (HARQ) retransmission in the unit of transport blocks (TBs) is supported, whereas 5G may additionally support code block group (CBG)-based HARQ retransmission in which a plurality of code blocks (CBs) are bundled.

In addition, to improve a network of the system, technologies such as evolved small cell, advanced small cell, cloud radio access network (RAN), ultra-dense network, device to device (D2D) communication, wireless backhaul, vehicular communication network (e.g., a V2X network), cooperative communication, coordinated multi-points (COMP), and received-interference cancelation, have been developed.

The Internet has evolved from a human-centered connection network, through which humans generate and consume information, to an Internet-of-things (IoT) network that exchanges and processes information between distributed elements such as objects. Internet of everything (IoE) technology in which a big data processing technology through a connection with a cloud server or the like is combined with the IoT technology has also emerged. To implement IoT, technical factors, such as sensing technology, wired/wireless communication, network infrastructure, service-interface technology, and security technology are required, and research on technologies, such as a sensor network, machine to machine (M2M) communication, machine type communication (MTC), and the like for connection between objects has recently been conducted. In an IoT environment, through collection and analysis of data generated from connected objects, an intelligent internet technology service to create new value for peoples' lives may be provided. IoT may be applied to various fields, such as smart homes, smart buildings, smart cities, smart cars or connected cars, smart grids, health care, smart home appliances, or high-tech medical services, through the convergence and combination of existing information technology (IT) and various industries.

Accordingly, various attempts are being made to apply 5G communication systems to IoT networks. For example, technologies such as a sensor network, M2M communication, and MTC are implemented using 5G communication technologies such as beamforming, MIMO, array antenna schemes, etc. The application of wireless access network (cloud RAN) as the big data processing technology described above may be an example of convergence of 5G communication technology and IoT technology. As such, in a communication system, a plurality of services may be provided to a user, and to provide the plurality of services to the user, a method for providing each of the plurality of services in the same time period according to the characteristics and an apparatus using the method is required. Various services provided in a 5G and 6G communication system are being studied, and one of them is a service that satisfies requirements of low latency and high reliability. In addition, the demand for mobile services is exploding, and location based services (LBSs) and positioning support services, which are mainly driven by two main requirements, i.e., emergency services and commercial applications, are rapidly growing.

In particular, positioning schemes supported in 3GPP communication systems can be classified into RAT-dependent positioning and RAT-independent positioning schemes. RAT-dependent positioning is a method in which positioning is performed using radio signals defined in 3GPP. In contrast, RAT-independent positioning is a method in which positioning is performed using radio signals other than radio signals defined in 3GPP, such as BLE, Wi-Fi, sensor, and a global navigation satellite system (GNSS). In RAT-independent positioning, a location server (LS) (e.g., location management function (LMF)) that manages positioning can provide information for positioning to a UE. For example, in the case of Wi-Fi, the location of an access point (AP), a Wi-Fi version number (i.e., 11b/g/n), a service set ID (SSID), a basic service set ID (BSSID), etc. can be provided from the LMF to the UE.

To more accurately perform positioning, there is a need in the art for a method for supporting UWB positioning as a RAT-independent positioning scheme.

### SUMMARY

The disclosure has been made to address at least the above-mentioned problems and/or disadvantages and to provide at least the advantages described below.

Accordingly, an aspect of the disclosure is to provide a method and procedure for supporting positioning in a cellular system, such that more accurate positioning may be achieved by supporting UWB positioning in the cellular system.

In accordance with an aspect of the disclosure, a method performed by a first UE in a wireless communication system includes receiving, from an LMF, assistance data including a UWB anchor list, receiving, from a plurality of UWB anchors, a plurality of UWB messages including UWB measurements, determining location information of the first UE based on the plurality of UWB messages, and transmitting, to the LMF, the determined location information.

In accordance with an aspect of the disclosure, a method performed by a second UE in a wireless communication system includes transmitting, to a first UE using a sidelink positioning protocol (SLPP), a request message for UWB information, and receiving, from the first UE, a plurality of UWB messages including UWB measurements, wherein the plurality of UWB messages is obtained by the first UE from a plurality of UWB anchors.

In accordance with an aspect of the disclosure, a first UE in a wireless communication system includes a transceiver, and a controller coupled with the transceiver and configured to receive, from an LMF, assistance data including a UWB anchor list, receive, from a plurality of UWB anchors, a plurality of UWB messages including UWB measurements, determine location information of the first UE based on the plurality of UWB messages, and transmit, to the LMF, the determined location information.

In accordance with an aspect of the disclosure, a second UE in a wireless communication system includes a transceiver, and a controller coupled with the transceiver and configured to transmit, to a first UE using an SLPP, a request message for UWB information, and receive, from the first UE, a plurality of UWB messages including UWB measurements, wherein the plurality of UWB messages is obtained by the first UE from a plurality of UWB anchors.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a positioning procedure in Uu according to an embodiment;

FIG. 2 illustrates a positioning procedure in SL according to an embodiment;

FIG. 3 illustrates a method for supporting UWB as one of RAT-independent positioning schemes according to an embodiment;

FIG. 4A illustrates data exchange between an LMF and a UE that is performed to support RAT-independent positioning according to an embodiment;

FIG. 4B illustrates information exchange between an LMF and a UE that is performed to support RAT-independent positioning according to an embodiment;

FIG. 5 illustrates cluster information of a UWB anchor according to an embodiment;

FIG. 6 illustrates a transfer cycle of UWB messages transferred by UWB anchors according to an embodiment;

FIG. 7 illustrates information exchange between an LMF and a base station in RAT-independent positioning according to an embodiment;

FIG. 8 illustrates information exchange between UEs for supporting RAT-independent positioning according to an embodiment;

FIG. 9 illustrates an internal structure of a UE according to an embodiment; and

FIG. 10 illustrates an internal structure of a base station according to an embodiment.

### DETAILED DESCRIPTION

Embodiments of the disclosure will be described in detail referring to the accompanying drawings. A detailed description of known functions or configurations incorporated herein will be omitted for the sake of clarity and conciseness.

For the same reasons, some elements may be exaggerated or schematically shown. The size of each element does not necessarily reflect the actual size of the element. The same reference numeral may be used to refer to the same element throughout the drawings.

The disclosure may be embodied in many different forms and should not be construed as limited to embodiments set forth herein. Rather, these embodiments are provided so that this disclosure will be thorough and complete, and will fully convey the scope of the disclosure only defined by the claims to one of ordinary skill in the art.

Embodiments of the disclosure will generally be described based on a new RAN (RAN), and a core network, i.e., a packet core (a 5G system, a 5G core network, or a next generation (NG) core), in the 5G mobile communication standard specified by the mobile communication standardization organization, 3rd generation partnership project long term evolution (3GPP LTE), but it will be understood by those skilled in the art that the gist of the disclosure is applicable to other communication systems having similar technical backgrounds without significantly departing from the scope of the disclosure.

Hereinafter, for convenience of description, some terms and names defined in standards of 3GPP (standards of 5G, NR, LTE, or similar systems) may be used. However, the disclosure is not limited by these terms and names and may be similarly applied to systems that conform other standards.

As used herein, terms for identifying access nodes and referring to network entities, messages, interfaces between network entities, and a variety of identification information, are used for convenience of description. Accordingly, the disclosure is not limited to the terms used herein, which may be replaced with other terms with reference to objects having equivalent technical meanings.

Although UWB is not included in the RAT-independent positioning schemes supported by the existing 3GPP, UWB is a technology that can improve positioning accuracy by using wideband signals and has already been implemented and used in many devices. Therefore, when UWB is included as the RAT-independent positioning scheme, the corresponding positioning scheme can be used when UWB is implemented. Disclosed herein are methods for supporting UWB positioning, exchanging information between an LS (e.g., an LMF) and a UE, information exchange between an LS and a base station, information exchange between UEs, and a signaling procedure and signaling contents for supporting such information exchange.

As a positioning method for measuring the location of the UE, a method for using a positioning signal transferred through a downlink (DL) and uplink (UL) (hereinafter referred to as Uu) between the UE and the base station is explained. The positioning signal can be a DL positioning reference signal (PRS) or a UL sounding reference signal (SRS). The method using a positioning signal transferred through a DL and UL of the UE and base station may be referred to as RAT-dependent positioning. In addition, other positioning methods may be classified as RAT-independent positioning. Particularly, in an LTE system, as a RAT-dependent positioning scheme, methods such as observed time difference of arrival (OTDOA), UL time difference of arrival (UTDOA), and enhanced cell identification (E-CID) may be used. In an NR system, methods such as DL time difference of arrival (DL-TDOA), DL angle-of-departure (DL-AOD), multi-round trip time (multi-RTT), NR E-CID, UL time difference of arrival (UL-TDOA), and UL angle-of-arrival (UL-AOA) may be used. RAT-independent positioning schemes may use methods such as GNSSs, sensor, wireless local area network (WLAN), and Bluetooth™.

Protocols such as LTE positioning protocol (LPP), LTE positioning protocol annex (LPPa), and NR positioning protocol annex (NRPPa) may be used for positioning protocols. LPP may be considered as a positioning protocol defined between a UE and an LS. LPPa and NRPPa may be considered as protocols defined between a base station and an LS, which manages location measurement and may perform an LMF. The LS may be referred to as an LMF or other names. In both LTE and NR systems, LPP is supported, and positioning capability exchange, assistance data transfer, location information transfer, error handling, and abort are roles for positioning that may be performed through LPP.

The base station may transparently enable the UE and LS to exchange positioning information while the UE and LS perform the above roles through LPP. As such, the base station is not involved in the exchange of positioning information between the UE and the LS. In the positioning capability exchange, the UE may exchange supportable positioning information with the LS. For example, the supportable positioning information may indicate whether a positioning method supported by the UE is UE-assisted, UE-based, or both. UE-assisted positioning is a scheme in which the UE delivers only a measured value for a positioning scheme to the LS based on a received positioning signal without directly measuring the absolute position of the UE, and the absolute position of the UE is calculated by the LS. The absolute position may refer to two-dimensional (x,y) and three-dimensional (x,y,z) coordinate location information of the UE based on longitude and latitude. In contrast, UE-based positioning may be a scheme in which the UE may directly measure the absolute position of the UE. For this, the UE needs to receive a positioning signal, together with location information of the source of the positioning signal. Another example may include RAT-independent methods that the UE may support. For example, the UE is equipped with a receiver capable of supporting UWB-based positioning. Thus, whether UWB positioning measurements are possible may be exchanged as positioning capability information.

Assistance data transfer may be a significantly important factor in positioning, to accurately measure the location of the UE. In this case, the LS may provide the UE with configuration information about the positioning signal, information about candidate cells and transmission reception points (TRPs) to receive the positioning signal, and the like. For example, when DL-TDOA is used, the information about the candidate cells and TRPs to receive the positioning signal may be information about reference cells, reference TRPs, neighbor cells, and neighbor TRPs. In addition, a plurality of candidates for neighbor cells and neighbor TRPs may be provided, together with information about a preferred cell and TRP to be selected by the UE to measure the positioning signal. In order for the UE to accurately measure the location, it is necessary to properly select information about candidate cells and TRPs to be used as a reference. For example, when a channel for a positioning signal received from a corresponding candidate cell and TRP is a line-of-sight (LOS) channel, i.e., a channel having fewer non-LOS (NLOS) channel components, the accuracy of positioning measurement may increase. Therefore, when the LS provides the UE with information about candidate cells and TRPs, which are the reference for performing positioning by collecting various pieces of information, the UE may perform more accurate positioning measurement. The assistance data transfer may also be vital for RAT-independent positioning. For example, when UWB-based DL-TDOA is used, a UWB UE may measure DL-TDOA by receiving UWB messages transmitted by UWB anchors. To make this possible, information related to UWB anchors needs to be provided to the UWB UE and the corresponding information may be provided as assistance data through LPP.

The location information transfer may be performed through LPP. The LS may request location information from the UE, and the UE may provide measured location information to the LS in response to the corresponding request. In UE-assisted positioning, the corresponding location information may be a measured value with respect to a positioning scheme based on a received positioning signal. In UE-based positioning, the corresponding location information may be a value corresponding to the longitude, latitude, and altitude information of the UE, or may be two-dimensional (x,y) and three-dimensional (x,y,z) coordinate location values of the UE. When the LS requests the location information from the UE, the LS may include required accuracy, response time, and the like, in positioning quality-of-service (QOS) information. When the corresponding positioning QoS information is requested, the UE needs to provide the LS with the measured location information to satisfy the corresponding accuracy and response time. When it is impossible to satisfy the QoS, the UE may consider error handling and abort. However, this is only an example, and error handling and abort may be performed on positioning in other cases than those in which it is impossible to satisfy QoS.

A positioning protocol defined between the base station and the LS is referred to as LPPa in LTE systems. E-CID location information transfer, OTDOA measurement information transfer, general error state reporting, and assistance information transfer are functions that may be performed between the base station and the LS.

In addition, a positioning protocol defined between the base station and the LS may be referred to as NRPPa in NR systems, and includes the roles performed by LPPa Positioning information transfer, additional measurement information transfer, and TRP information transfer may be performed between the cell and the LS.

The base station may also be referred to as TRP or radio unit (RU), which indicates that the functions performed in a typical base station may be separated into a part that transmits and receives signals and a part that processes the corresponding signals. Through this separation, additional parts that transmit and receive signals may be implemented and installed. Positioning measurements may also be made based on the part that transmits and receives signals. While in the LTE system, positioning measurements are defined based on the base station (or cell), in NR and future communication systems, positioning measurements are defined based on the part that transmits and receives signals separated from the base station, so that the parts where positioning measurements are possible increase and positioning performance may be improved.

Unlike in LTE systems: more positioning schemes are supported in NR systems. Therefore, various positioning schemes may be supported through the positioning information transfer. For example, positioning measurement may be performed by the base station through a positioning SRS transferred by the UE. Therefore, with the positioning information, information related to configuration and activation/deactivation of a positioning SRS may be exchanged between the base station and the LS.

The measurement information transfer is a function of exchanging, between the base station and the LS, information related to multi-RTT, UL-TDOA, and UL-AOA, which are not supported in LTE systems. The TRP information transfer is a role of exchanging information related to performing of TRP-based positioning, because TRP-based positioning may be performed in NR systems whereas base station (cell)-based positioning is performed in LTE systems. Herein, information related to RAT-independent positioning is transferred through LPPa and NRPPa. This assumes that a function capable of performing RAT-independent positioning is installed and connected to a part capable of positioning measurement, such as a base station (or cell) or TRP. In this case, the measurement result for RAT-independent positioning may be delivered to the base station (or cell) or TRP.

A method using a positioning signal transferred through a sidelink (SL) between UEs as a positioning method for measuring the location of the UE is described herein. The positioning signal may be an SL PRS. A method using a positioning signal transferred through SL can be referred to as RAT dependent positioning. In addition, other positioning methods may be classified as RAT-independent positioning. In the NR system, methods such as SL-TDOA, SL-AOA, and SL round trip time (SL-RTT) may be used as RAT-dependent positioning schemes. In contrast, methods such as GNSS, sensor, wireless local area network (WLAN), Bluetooth™, and UWB may be supported through SL as RAT-independent positioning schemes.

In SL, a protocol for positioning may be defined similarly to that in Uu. RAT-dependent positioning in Uu is possible only when the UE is within the coverage of the base station. When the UE performs communication using SL within the coverage of the base station, the positioning protocol defined in Uu may be used and positioning may be performed through an LS. However, RAT-dependent positioning of SL may be possible even when the UE is outside the coverage of the base station. In this case, an SL LS and SLPP may be defined. Unlike in Uu, in the SLPP, the UE is connected to the LS. The role of the SL LS and positioning protocol may be similar to those in Uu. In the disclosure, information related to RAT-independent positioning is transferred through SLPP.

This assumes that a function capable of performing RAT-independent positioning is installed and connected to a part where positioning measurement is possible, such as a base station (or cell) or TRP. In this case, the measurement result for RAT-independent positioning may be delivered to the base station (or cell) or TRP.

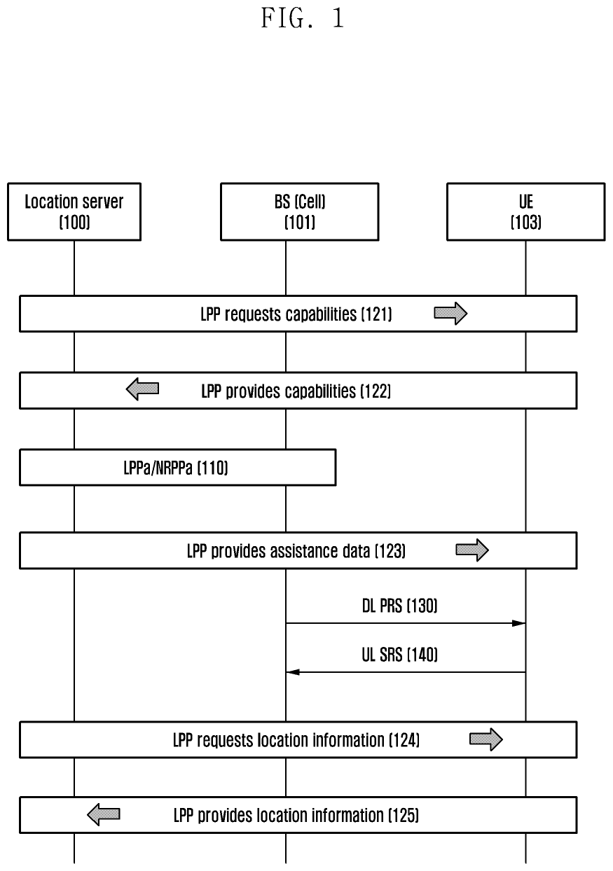

FIG. 1 illustrates a positioning procedure in Uu according to an embodiment.

Referring to FIG. 1, an LS 100 may request UE capability from a UE 103 through LPP in step 121. The UE 103 may provide positioning information that may be supported to the LS 100 in step 122. For example, whether the positioning method supported by the UE is UE-assisted or UE-based, or both. In addition, the LS 100 and base station 101 may exchange information necessary for positioning with each other through LPPa or NRPPa in step 110. For example, the base station 101 may provide positioning measurement information received from the UE to the LS 100 through UL SRS 140. In addition, the base station may transfer TX timing error group (TEG) information or RX TEG information of the base station 101.

The LS 100 may transfer assistance data to the UE 103 through LPP in step 123. For example, the base station 101 may transfer DL PRS 130 to the UE 103 including the configuration information of the positioning signal, or the UE 103 may transfer UL SRS 140 for positioning to the base station 101. The LS 100 may request location information from the UE 103 through LPP in step 124. Then, the UE 103 may provide location information through LPP in step 125. The location information provided by the UE 103 in step 125 may be positioning measurement information through DL PRS 130 in the case of the UE assist scheme. In contrast, in the case of the UE-based method, it may be coordinate location information calculated by the UE. The UE 103 may transfer not only the location information but also the UE's RX TEG information in step 125.

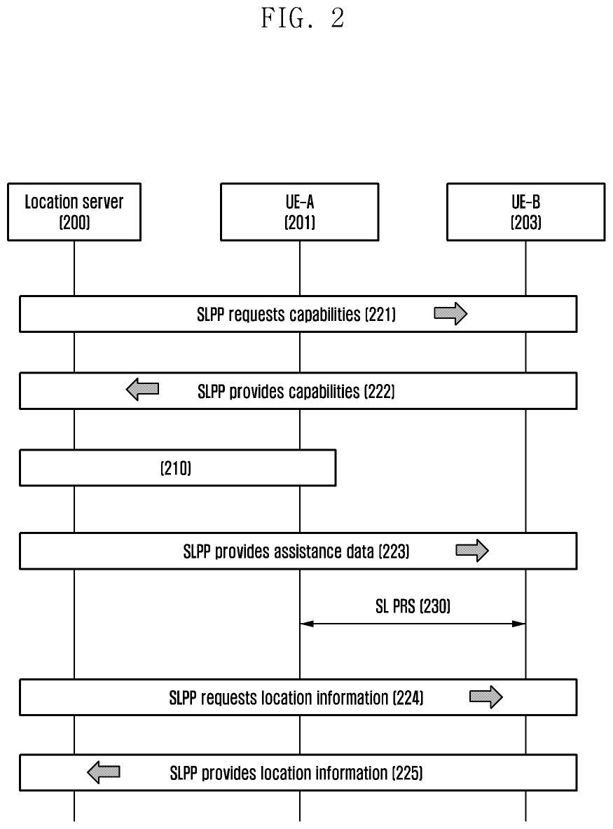

FIG. 2 illustrates a positioning procedure in SL according to an embodiment.

Referring to FIG. 2, an LS 200 may request UE capability from a UE-B 203 performing positioning measurement and calculation through SLPP in step 221. The UE-A 201 may be referred to as a server UE and a UE connected to the LS 200. However, the disclosure is not limited thereto and may be referred to by a different term. The UE-B 203 provides positioning information that may be supported to the LS 200 connected to the server UE-A 201 in step 222, such as whether the positioning method supported by the UE is UE-assisted, UE-based, or both. When the UE is within the coverage of the base station; the LS 200 may be connected to the base station. Alternatively, when the UE is outside the coverage of the base station, the LS 200 may be connected to the UE. In addition, SLPP may include functions similar to or identical to the LPPa or NRPPa described above. Specifically, in step 210, the location server 200 and server UE-A 201 exchange information necessary for positioning, and the steps described in the LPPa or NRPPa may be additionally performed. For example, the server UE-A 201 may provide positioning measurement information through the SL PRS 240 received from another UE-B 203 to the LS 200 connected to the UE. In addition, the UE may transfer TX TEG information or RX TEG information of the server UE-A 201.

The LS 200 may transfer assistance data to another UE-B 203 through the server UE-A 201 through SLPP in step 223. For example, by including the configuration information of a positioning signal, the server UE may transfer an SL PRS 230 to UE-B 203 or UE-B 203 may transfer the SL PRS 230 for positioning to the server UE. The LS 200 may request location information to another UE-B 203 through SLPP in step 224 through the server UE-A 201. Then, the UE-B 203 may provide location information to the LS 200 connected to the server UE-A 201 through SLPP in step 225. The location information provided by the UE in step 225 may be positioning measurement information through SL PRS 230 in the UE assist scheme, and may be coordinate location information calculated by the UE in the UE-based scheme. The UE-B 203 may transfer not only the location information but also the TX TEG information or the RX TEG information of the UE-B 203 in step 225.

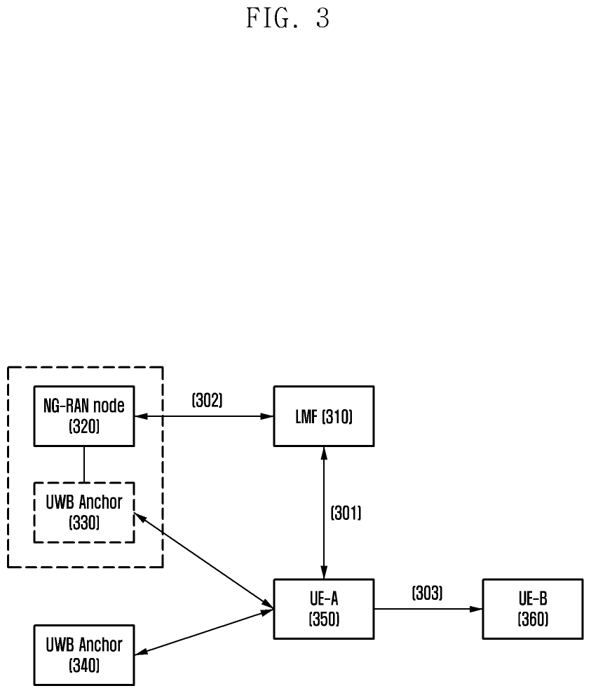

FIG. 3 illustrates a method for supporting UWB as one of RAT-independent positioning schemes according to an embodiment. Referring to FIG. 3, not only information exchange 301 between an LMF 310 and a UE-A 350, but also information exchange 302 between the LMF 310 and a base station and information exchange 303 between UEs may be utilized. In the existing RAT-independent positioning, the information exchange 301 between the LMF 310 and a UE is supported. Therefore, the method for information exchange 302 between the LMF 300 and a base station and method for information exchange 303 between UEs may also be applied to positioning through A-GNSS, Sensor, WLAN, and Bluetooth, not through UWB.

In FIG. 3, an NG-RAN node 320 indicates a node capable of RAT-dependent positioning measurement, such as a base station (or cell) or TRP. Also, a function (UWB anchor) 330 capable of performing RAT-independent positioning may be installed and connected to the NG-RAN node 320. The connection between the NG-RAN node 320 and the function 330 capable of performing RAT-independent positioning may be wirelessly or wired. While UWB anchor 330 is illustrated in FIG. 3, other functions capable of performing RAT-independent positioning may be used. For example, the UWB anchor 330 may include a WLAN access point (AP) function. Also, the UWB anchor 330 may not be connected to the NG-RAN node 320. In general, a UWB UE may transmit and receive UWB messages with a UWB anchor 340 which may perform the following UWB measurements.

Time of flight (ToF) measurement: ToF may be measured from two way ranging (TWR) results for UWB message transmission and reception, and a distance (range) between the UWB anchor and the UE may be derived.

Time difference of arrival (TDoA) measurement: UL TDoA may be measured using a time difference between the UWB anchors that have received the UWB message transferred by the UE.

AoA measurement for UWB message reception may be measured.

Received signal strength indicator (RSSI) measurement: RSSI for UWB message reception may be measured.

In FIG. 3, both UE-A 350 and UE-B 360 are equipped with UWB receivers and represent UEs capable of receiving UWB signals. The UE-A 350 may be a UE located within the coverage of a base station, connected to the base station, and capable of receiving positioning-related information from the LMF 310. The UE-B 360 may be a UE located outside the coverage of the base station. One or both of the UE-A 350 and UE-B 360 may be a server UE. A UE equipped with a UWB receiver may perform the following UWB measurements.

ToF may be measured from TWR results for UWB message transmission and reception, and a distance (range) between the UEs may be derived.

DL-TDoA may be measured using a time difference between UWB messages transferred by different UWB anchors.

AoA measurement for UWB message reception may be measured.

RSSI measurement: RSSI for UWB message reception may be measured.

In FIG. 3, information exchange 301 between the LMF 310 and UE-A 350 may include assistance data for RAT-independent positioning that the LMF 310 provides to the UE-A 350, and may include location information that the UE-A 350 provides to the LMF 310 through RAT-independent positioning. For example, when UWB-based DL-TDOA is used, the UWB UE may receive the UWB messages transmitted by UWB anchors and measure DL-TDOA. To enable this method, information related to UWB anchors must be provided to the UE-A 350 by the LMF 310. In addition, a result measured by the UE-A 350 may be provided to the LMF 310, as described in detail below.

In FIG. 3, information exchange 302 performed between the LMF 310 and the base station 320 is illustrated. When a function capable of performing RAT-independent positioning is connected to the NG-RAN node 320 capable of RAT-dependent positioning measurement, such as the base station (or cell) or TRP, the measurement result for RAT-independent positioning performed by the UWB anchor 330 may be delivered to the NG-RAN node 320, as described in detail below.

In FIG. 3, the UE-B 360 may be located in a shadow area with respect to the UWB anchor 330 or 340 and may not be able to receive UWB messages from the UWB anchor or such reception may be performed smoothly, but the UE-A 350 may be located in an environment where transmission and reception with a surrounding UE e.g., UE-B) are smoothly performed. In this case, the location of UE-A 350 may be determined from range information measured by receiving UWB signals transmitted and received between the UEs. The information related to RAT-independent positioning may be shared between the UEs through SLPP, as described in detail below in Embodiment 3.

The positioning method presented in the disclosure may be applied to the downlink, UL, and SL of a cellular system.

In accordance with an embodiment, information may be exchanged between an LMF and a UE to support UWB-based RAT-independent positioning. The protocol between the LMF and the UE may correspond to the LPP described above. However, the protocol between the LMF and the UE is not limited thereto and may be newly defined with a different name.

First, the UE should provide capability information for RAT-independent positioning to the LMF. In the case of UWB-based positioning, the corresponding capability information may indicate whether the UE is equipped with a UWB receiver and is capable of transmitting and receiving UWB signals. Alternatively, the corresponding capability information may indicate whether the UE is capable of performing UWB measurements. Such capability information of the UE may be provided to the LMF.

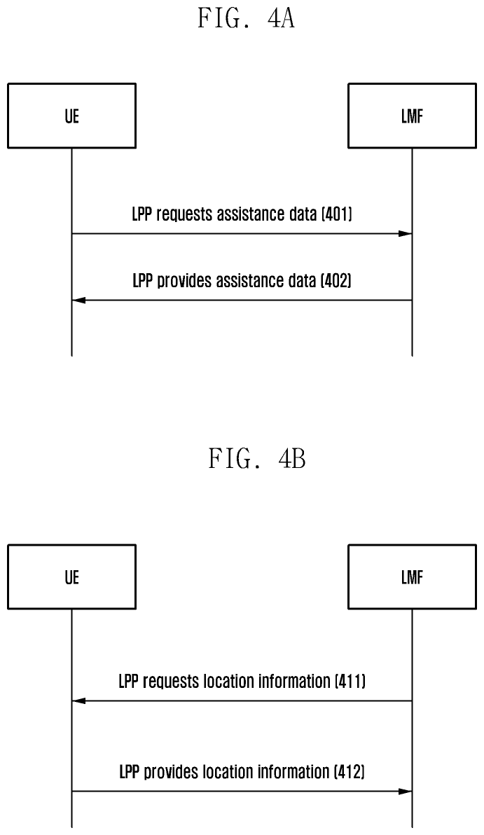

FIG. 4A illustrates data exchange between an LMF and a UE that is performed to support RAT-independent positioning according to an embodiment.

Referring to FIG. 4A, the LMF may request assistance data from the UE through a protocol between the LMF and the UE in step 401. The UE that has received the corresponding request may provide the assistance data to the LMF in step 402. When UWB-based positioning is used, the details of the assistance data are provided in Table 1 below. FIG. 4A shows an assistance data exchange method initiated by the LMF. In an assistance data exchange method initiated by the UE, the UE may directly provide the assistance data to the LMF without a request from the LMF.

FIG. 4B illustrates information exchange between an LMF and a UE that is performed to support RAT-independent positioning according to an embodiment.

Referring to FIG. 4B, the LMF may request location information from the UE through a protocol between the LMF and the UE in step 411. The details of the location information may be based on the explanation of the LPP described above. The UE that has received the location information request may provide the location information to the LMF in step 412. When UWB-based positioning is used, the details of the location information are provided in Table 2 below. FIG. 4B shows an information exchange method initiated by the LMF. In an location information exchange method initiated by the UE, the UE may directly provide location information to the LMF without a request from the LMF.

Tables 1-5 below present information that the LMF provides to the UE to support RAT-independent positioning according to an embodiment. The information presented in Tables 1-5 may correspond to assistance data when UWB-based positioning is used. The assistance data may include all or part of Tables 1-5.

Table 1 shows information that may be transferred from the LMF to the UE.

TABLE 1
Number of clusters

| | | |
|---|---|---|
| UWB cluster | Cluster #1 | UWB anchors List |
| information | information | Active ranging round index |
| | Cluster #2 | UWB anchors List |
| | information | Active ranging round index |
| | . . . | |
| | Cluster #N | UWB anchors List |
| | information | Active ranging round index |
| UWB configuration | | |

Table 2 shows a UWB anchor List.

TABLE 2

| | | |
|---|---|---|
| UWB anchor List | UWB anchor #1 | Anchor Type |
| | | Anchor Location |
| | UWB anchor #2 | Anchor Type |
| | | Anchor Location |
| | . . . | |
| | UWB anchor #n | Anchor Type |
| | | Anchor Location |

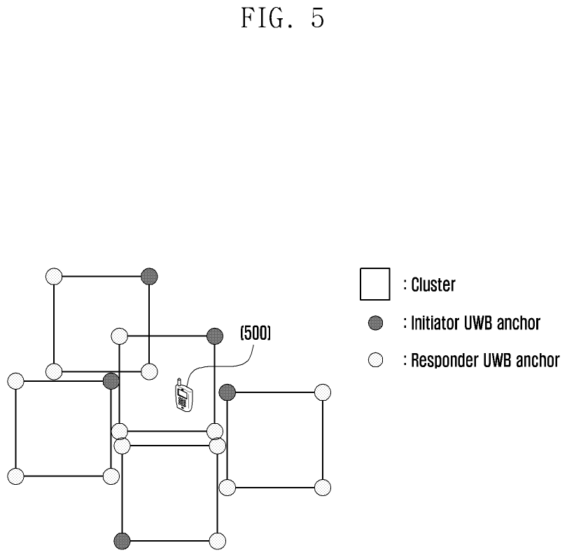

In Table 1, UWB positioning may be achieved through the constitution of a cluster constituted with a plurality of UWB anchors. For example, in order for the UE to measure UWB-based DL TDoA, a DL TDoA network constituted with one or plurality of clusters needs to be constituted. Therefore, the number of clusters and cluster information may be included in the assistance data as in Table 1. FIG. 5 illustrates cluster information of a UWB anchor according to an embodiment.

FIG. 5 illustrates an example in which five clusters are constituted for positioning a UE 500 according to an embodiment. Referring to FIG. 5, one cluster 501 can be composed of one initiator UWB anchor 502 and one or more responder UWB anchor(s) 503. One cluster is constituted with one initiator UWB anchor and four responder UWB anchors. The Initiator UWB anchor 502 performs UWB positioning. When the Initiator UWB anchor 502 transfers a UWB message, the responder UWB anchor(s) 503 that has received the UWB message transfers a responder UWB message. Then, the UEs in the cluster may perform DL TDoA measurement by overhearing/receiving the corresponding UWB messages. Specifically, DL TDoA may be defined as shown below in Equation (1).

DL TDoA=TDoA between initiator UWB anchor and responder UWB anchor (1)

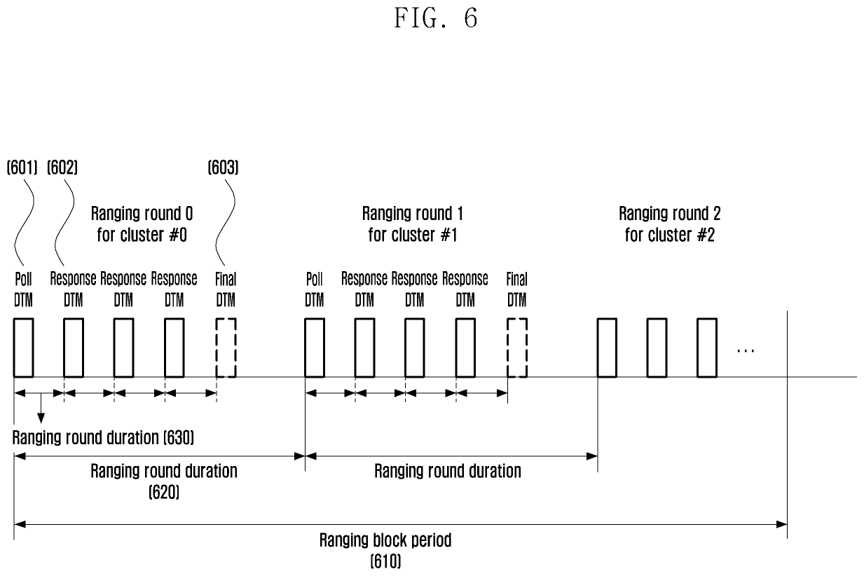

In Table 1, the cluster information may include information about the UWB anchors that constitute the corresponding cluster (UWB anchor List) and information about the index of the ranging round in which the corresponding UWB anchor operates (active ranging round index). The ranging round index will be explained below with reference to FIG. 6.

The UWB anchor List may be constituted as shown in Table 2. The UWB anchor List may include information about the anchor type and anchor location of each UWB anchor. The anchor type may be either an initiator anchor or a responder anchor. Additionally, the UWB anchor list may include information about the transfer power, antenna gain, and coverage area of the UWB anchor.

The anchor location may be expressed in coordinates of WGS-84 or a two, three-dimensional relative coordinate system. Table 3 below shows when the anchor location is expressed in WGS-84 coordinates.

TABLE 3

| Parameter | Size (bits) | |
|---|---|---|
| Anchor Latitude | 33 | Latitude of the UWB anchor |
| Anchor | 33 | Longitude of the UWB anchor |
| Longitude | | |
| Anchor Altitude | 30 | Altitude of the UWB anchor |

In Table 3, the anchor latitude and longitude values are 33-bit long and may be encoded in Q9.24 format. The 33-bit Q9.24 format may be expressed as 1 bit for sign, 8 bits for integer part, and 24 bits for fractional part. The sign may be 2's complement notation.

The anchor latitude may be a value in the range of [−90, 90] and may have a resolution of about 6.6 mm when expressed in the above Q9.24 format. The anchor latitude is a value in the range of [−180, 180] and has the same resolution as the anchor latitude. Table 4 below shows when the anchor location is expressed in a relative coordinate system.

TABLE 4

| Parameter | Size (bits) | Notes |
|---|---|---|
| Anchor X | 28 | X of the DT-Anchor in millimeter in a given coordinate system |
| Anchor Y | 28 | Y of the DT-Anchor in millimeter in a given coordinate system |
| Anchor Z | 24 | Z of the Anchor in millimeter in a given coordinate system |

In Table 4, anchor location information that may be used in the case of representing the UWB anchor location in a three-dimensional space as x, y, and z coordinates is shown. The X and Y coordinate axis values may be represented as Q28.0 of 28 bits, and the Z coordinate value may be represented as Q24.0 of 24 bits, and may be represented in mm units.

In Tables 1-4, the UWB configuration information may include various configuration information for positioning. For example, the configuration information on the currently used UWB positioning method may be included. For example, information about whether the method operates as TWR or one way ranging (OWR) may be configured. For example, DL TDoA is a scheme belonging to OWR. In addition, information about the transfer cycle of UWB messages transferred by UWB anchors may be included. The UWB configuration information may include the UWB MAC configuration parameters listed in Table 1-E below. In addition to the parameters listed in Table 5 below, UWB configuration information may additionally include default MAC parameters required for UWB operation, such as Multi-node mode, RFRAME configuration Preamble Code Index, and MAC FCS Type. In addition, UWB configuration information may also include UWB PHY parameters, such as PREAMBLE DURATION, NUMBER OF STS SEGMENT, PSDU DATA RATE, and STS LENGTH.

TABLE 5

| UWB | | | |
|---|---|---|---|
| Configuration | Size | | |
| parameter | (octets) | Notes | Default value |
| Session | 4 | An identifier that identifies the UWB | Randomly- |
| Identifier | | session operating for positioning and is a | generated value |
| (Session ID) | | random value of 4 bytes. | |
| Ranging | 1 | Has one of the following values, depending | 5 (may use DL- |
| scheme | | on the UWB ranging method used for | TDoA ranging |
| (Ranging | | positioning. | scheme as the |
| Round Usage) | | 0: OWR | default for |
| | | 1: Single-sided two-way ranging (SS- | positioning.) |
| | | TWR) with Deferred Mode | |
| | | 2: Double-sided two-way ranging (DS- | |
| | | TWR) with Deferred Mode | |
| | | 3: SS-TWR with Non-deferred Mode | |
| | | 4: DS-TWR with Non-deferred Mode | |
| | | 5: OWR DL-TDOA | |
| Block | 4 | Length of the ranging block, in units of ms. | 200 |
| Duration | | | |
| Round | 1 | The number of ranging slots that fall within | 25 |
| Duration | | one ranging round. | |
| Slot Duration | 2 | Length of ranging slot, in units of RSTU | 2400 RSTU |
| | | (=416/499.2 us) | |
| Channel | 1 | Number of the UWB channel to be used | 9 |
| Number | | | |
| PRF Mode | 1 | UWB PRF mode to use, which has one of | 0 |
| | | the two values below. | |
| | | 0: BPRF mode | |
| | | 1: HPRF mode | |
| STS Config | 1 | Type of scrambled timestamp sequence to | 0 |
| | | use, either a Static STS with a lower | |
| | | security level or a dynamic STS with a | |
| | | higher security level. | |
| | | 0: Static STS | |
| | | 1: Dynamic STS | |
| Vendor ID | 2 | Vendor identifier, one of the input values | Randomly- |
| | | used to create STS, having 2 bytes of | generated value |
| | | random value | |
| Static STS IV | 6 | Vendor identifier, one of the input values | Randomly- |
| | | used to create STS, having 6 bytes of | generated value |
| | | random value | |

FIG. 6 illustrates a transfer cycle of UWB messages transferred by UWB anchors according to an embodiment.

Referring to FIG. 6, the transfer time and order of UWB messages transferred by the UWB anchors may be determined according to the cluster and according to the initiator UWB anchor and responder UWB anchor. This may be a method for minimizing interference between UWB messages. The Poll DTM (DL TDoA Message) in step 601 indicates a UWB message transferred by the initiator UWB anchor. The response DTM in step 602 indicates a UWB message transferred by the responder UWB anchor(s). The final DTM in step 603 may be selectively transferred according to the lower ranging scheme used in DL-TDoA and indicates the last UWB message transferred by the initiator UWB anchor in one ranging round duration. Therefore, the time at which the UWB message is transferred from the UWB anchors may be determined according to the configuration information of a range block period 610, ranging round duration 620, ranging slot duration 630, and Poll DTM 601, response DTM 602, and final DTM 603 configured as the UWB configuration information, and the receiving side may overhear/receive the UWB message by with reference to the corresponding information. The ranging block period 610 corresponds to the block duration of Table 5, the ranging slot duration 630 corresponds to the slot duration of Table 5, and the ranging round duration is obtained by multiplying the round duration and slot duration of Table 5.

Table 6 below shows information that the UE provides to the LMF when RAT-independent positioning is supported according to an embodiment. The information disclosed in Table 6 may correspond to location information and additional measurement information when the UWB-based positioning is used.

TABLE 6

| | | UE | UE-based/ |
|---|---|---|---|
| Information | | Assisted | Standalone |
| UWB Measurement | | Yes | No |
| results | | | |
| UE Location | UE position estimate with uncertainty | No | Yes |
| Information | shape | | |
| | Position Time Stamp | No | Yes |
| | Location Source (method(s) used to | No | Yes |
| | compute location) | | |

In Table 6, the UE may be in various states. In the case of standalone mode, positioning of the UE may be performed through the UWB receiver. The location information becomes the absolute position information of the UE, which may be a value corresponding to the longitude, latitude, and altitude information of the UE. In contrast, the absolute position information of the UE may be the two-dimensional (x, y) and three-dimensional (x, y, z) coordinate location values of the UE. In addition, information corresponding to the location uncertainty may be reported. The location information may be expressed as at least one of the parameters shown in Table 3 or Table 4. In addition, information about whether another positioning method has been used in the process of determining the location information may also be reported.

In the UE-based mode, whether positioning of the UE through UWB has been performed may be reported. The location information becomes the absolute position information of the UE, which corresponds to the longitude, latitude, and altitude information of the UE. In contrast, the absolute position information of the UE may be the two-dimensional (x,y) and three-dimensional (x,y,z) coordinate location values of the UE. The location information may be expressed as at least one of the parameters shown in Table 3 or Table 4. In addition, information corresponding to location uncertainty may be reported. In addition, information about whether another positioning method has been used in the process of determining the location information may also be reported.

In the UE assisted mode, positioning of the UE may be performed through the UWB receiver. Also, the location information means the measurement value for the positioning scheme based on the received positioning signal, not the absolute position of the UE. In this case, the absolute position of the UE may be calculated by the LMF. In Table 6, in the UE assisted mode, the measurement value measured through the UWB message may be reported by the subject for the UWB measurement results. When the UWB scheme used for positioning is DL-TDoA, the subject for the UWB measurement results may be constituted with UWB DL-TDoA measurement results information with the parameters shown below in Table 7 as elements. The following UWB DL-TDoA measurement results may be created and reported as many times as the number of UWB messages received by the UE.

TABLE 7

| Parameter | Description |
|---|---|
| MAC address | MAC address of the anchor transmitting the UWB message |
| of UWB anchor | received by the UE |
| Message Type | Type of UWB message received by the UE. It may be one of |
| | Poll DTM, response DTM, and final DTM. |
| Block Index | Index of the ranging block where the UWB message received |
| | by the UE has been transferred. |
| Round Index | Index of ranging round where the UWB message received by |
| | the UE has been transferred. |
| NLOS | Whether the UWB message received by the UE is non line of |
| | sight |
| Tx timestamp | Time at which the UWB message received by the UE has been |
| | transmitted from an UWB anchor. |
| Rx timestamp | Time at which the UWB message received by the UE has been |
| | received by the UE. |
| local CFO | Clock frequency offset between UE and UWB anchor as |
| | predicted by UE receiving an UWB message |
| Initiator Reply | Response delay time measured from the time the response DTM |
| Time | transferred by a specific responder UWB anchor is received |
| | when an Initiator UWB anchor transmits a final DTM |
| Responder | Response delay time from the time it receives the Poll DTM |
| Reply Time | transmitted by an Initiator UWB anchor when a responder |
| | UWB anchor transmits a response DTM |
| AoA Elevation | Elevation element value of the angle of arrival value measured |
| | when the UE receives a UWB message |
| AoA Azimuth | Azimuth element value of the angle of arrival value measured |
| | when the UE receives a UWB message. |
| Initiator- | ToF value between an Initiator UWB anchor and a specific |
| Responder ToF | responder UWB anchor. The corresponding value may help to |
| | accurately estimate the time difference of arrival value between |
| | an Initiator UWB anchor, responder UWB anchor, and the UE. |

When the UWB scheme used for positioning is TWR, the subject for UWB measurement results may be constituted with UWB TWR measurement results information with the parameters in Table 8 below as elements. The subject for UWB TWR measurement results below may be created and reported as many times as the number of UWB anchors on which the UE performs TWR.

TABLE 8

| Parameter | Description |
|---|---|
| MAC address of | MAC address of a UWB anchor performing TWR with the UE |
| UWB anchor | |
| Reply time | Response delay time between ranging initiation message and |
| | ranging response message exchanged between the UE and the |
| | UWB anchor |
| Round Trip time | Response delay time between ranging response message and |
| | ranging end message when the UE and UWB anchor perform |
| | DS-TWR |

In accordance with another embodiment, information may be exchanged between a LMF and a base station to support UWB-based RAT-independent positioning. The protocol between the LMF and the base station may correspond to the LPPa and NRPPa described above. However, the protocol between the LMF and the base station is not limited thereto and may be differently name. The base station (or cell) may also be referred to as a TRP or RU.

A node capable of RAT-dependent positioning measurement, such as a base station (or cell) or TRP needs to provide the LMF with capability information about whether a function capable of performing RAT-independent positioning is connected and what kind of RAT-independent positioning may be performed. The corresponding capability information may be information about whether the UWB anchor is additionally equipped to a node capable of RAT-dependent positioning measurement, such as a base station (or cell) or a TRP, and is capable of transmitting and receiving UWB signals. Alternatively, the capability information may indicate whether the corresponding node may perform UWB measurement. Such capability information of the UE may be provided as an LMF. The UWB may improve positioning accuracy by using wideband signals and has already been implemented and used in many devices. When a UWB anchor is equipped and connected to an NG-RAN node as in Embodiment 2, the presented positioning scheme may be useful when the UWB is deployed.

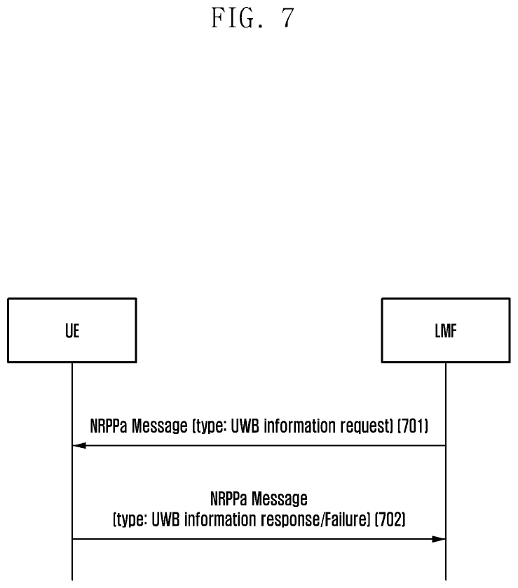

FIG. 7 illustrates information exchange between a LMF and a base station in RAT-independent positioning according to an embodiment.

Referring to FIG. 7, a LMF may request RAT-independent positioning information to an NG-RAN node through a protocol between the LMF and the NG-RAN node in step 701. The NG-RAN node that has received the corresponding request may provide the measured value through RAT-independent positioning to the LMF in response to the request in step 702. Also, the NG-RAN node may transfer a failure message to the LMF when this node cannot respond to the request. FIG. 7 illustrates when a request for UWB positioning information and a response thereto are performed and is further described in Table 9 below. FIG. 7 illustrates a method for exchanging RAT-independent positioning information initiated by the LMF. Alternatively, the NG-RAN node may directly provide RAT-independent positioning information to the LMF without a request from the LMF.

Table 9 shows information that the NG-RAN node provides to the LMF when RAT-independent positioning is supported according to an embodiment. The information disclosed in Table 9 may correspond to positioning information measured by a UWB anchor when UWB-based positioning is used.

TABLE 9

| Information | NG-RAN node assisted |
|---|---|
| UWB UL-TDoA Measurement results | Yes |

Table 10 below shows details of a UWB UL-TDoA Measurement result.

TABLE 10

| Parameter | Description |
|---|---|
| MAC address of | MAC address of the UWB anchor that receives the UL-TDoA |
| UWB anchor | blink message transmitted by the UE |
| UE identifier | UE identifier included in UL-TDoA transmitted by the UE |
| UL-TDOA blink | Sequence number of the UL-TDoA blink message transmitted |
| message sequence | by the UE |
| number | |
| Rx timestamp | MAC address of the UWB anchor that receives the UL-TDoA |
| | blink message transmitted by the UE |
| NLOS | Whether it is non-line-of-sight as the UWB anchor receives the |
| | blink message transmitted by the UE. |
| RSSI | RSSI value when the UWB anchor receives the blink message |
| | transmitted by the UE. |
| AoA Elevation | Elevation element of angle-of-arrival measured by the UWB |
| | anchor while receiving the blink message transmitted by the UE |
| AoA Azimuth | Azimuth element of angle-of-arrival measured by the UWB |
| | anchor while receiving the blink message transmitted by the UE |

The subject for UWB UL-TDoA measurement result in Table 10 may be created as many as the number of UWB anchors that have received the UL-TDoA blink message transmitted by the UE and reported to the LMF.

The LMF may obtain the TDoA value using the subjects of the same UL-TDoA blink message sequence number of the same UE identifier among the subjects for the reported UWB UL-TDoA measurement result.

Assuming that the UL-TDoA UWB anchors are exactly synchronized, the TDoA value may be calculated only by a difference in the received Rx timestamps. For example, when the Rx timestamps of two UWB anchors Z and Y that have received the blink message with sequence number 10 transferred by a UE identifier, A, are t_x and t_y, respectively, the TDoA for the UEs of anchors Z and Y may be calculated as t_x-t y. When the UL-TDOA UWB anchors are not precisely synchronized, additional values that allow the LMF to correct for this and obtain the TDoA may be included in the subject for UWB UL-TDoA measurement result and delivered to the LMF.

In accordance with another embodiment, information may be exchanged between a UE and a UE to support UWB-based RAT-independent positioning. The protocol between the UEs may correspond to the SLPP described above but not limited thereto and may be differently name. The UE should provide capability information for RAT-independent positioning to another UE. In this case, the other UE may be a server UE connected to the LMF. In the case of UWB-based positioning, the capability information may indicate whether the UE is equipped with a UWB receiver and capable of transmitting and receiving UWB signals. Alternatively, the corresponding capability information may indicate whether the UE may perform UWB measurements. In addition, the capability information may indicate whether UWB positioning information may be provided to another UE, and such information may indicate whether coordination between the UEs is possible. Such capability information of the UE may be provided to another UE. When UWB is deployed, there may be an environment where it is difficult for the UWB UE to receive UWB messages from the UWB anchor. In other words, a specific UWB UE may be located in a shadow area with respect to the UWB anchor. However, there may be an environment where the UWB UE may transmit and receive UWB messages well with a surrounding UWB UE that may perform positioning normally. In such cases, if UWB positioning information and UWB ranging measurements are shared between the UEs, UWB may be useful when deployed.

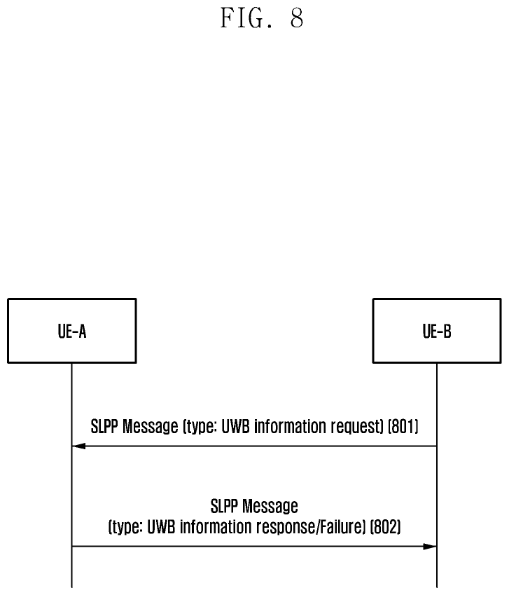

FIG. 8 illustrates information exchange between a UE and a UE for supporting RAT-independent positioning according to an embodiment.

Referring to FIG. 8, a UE-B may request RAT-independent positioning information to a UE-A in step 801. In this case, the UE-B may be a server UE connected to a LMF. Alternatively, the UE-B may be a UE within the coverage of a base station and connected to the LMF connected to the base station. The UE-A, which has received the corresponding request, may provide the UE-B with a value measured through RAT-independent positioning in response to the request in step 802. When a response to the request is impossible, the UE-A may transfer a failure message to the UE-B. FIG. 8 illustrates when a request for UWB positioning information and a response thereto are performed. When UWB-based positioning is used, details on positioning measurement values are shown in Table 11 below. FIG. 8 illustrates a method for exchanging RAT-independent positioning information according to a request from the UE. Alternatively, a specific UE may directly provide RAT-independent positioning information to another UE without a request from the UE.

Table 11 shows the information provided and exchanged between the UEs when RAT-independent positioning is supported. The information disclosed in Table 11 may correspond to location information when UWB-based positioning is used.

TABLE 11

| | | UE |
|---|---|---|
| Information | | Assisted |
| UWB TDoA | Measurement value created by the UE from messages | Yes |
| Measurement results | received from the DL-TDoA anchor | |
| UWB ToF | ToF measurement value by the UE performing TWR | Yes |
| Measurement results | with other UEs (UE-B) in the vicinity | |
| Cooperative UE's | Location information estimated by the UE (UE-B) | Yes |
| location | performing the above TWR | |

In Table 11, when the UE provides positioning information to another UE through UWB, the corresponding UE may be interpreted as being in UE assisted mode. In this case, the UE may have been positioned through a UWB receiver and the UE location information becomes the absolute position information of the UE. The absolute position information of the UE may be values corresponding to longitude, latitude, and altitude information of the UE. In contrast, the absolute position information of the UE may be two-dimensional (x, y) and three-dimensional (x, y, z) coordinate location values of the UE. The location information may be expressed as one of Table 3 or Table 4. In addition, information corresponding to location uncertainty and about whether another positioning method has been used to determine the location information may be reported. In FIG. 8, the ToF measurement value from the UE-B measured by the UE-A may be reported together.

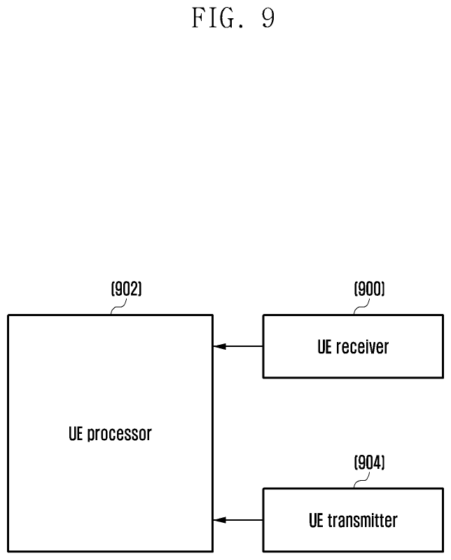

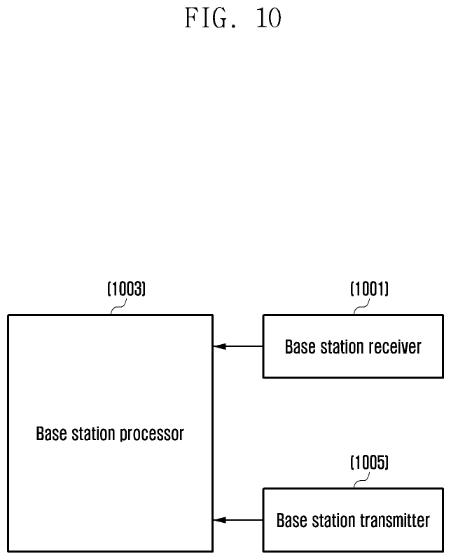

The transmitters, receivers, and processors of a UE and base station for performing the above embodiments are illustrated in FIGS. 9 and 10, respectively. The method, performed by a UE, of performing positioning is described in the above embodiments, and to perform the method, the receivers, processors, and transmitters of a base station and UE need to operate according to the embodiments.

FIG. 9 illustrates an internal structure of a UE according to an embodiment.

Referring to FIG. 9, the UE may include a UE receiver 900, a UE transmitter 904, and a UE processor 902. The UE receiver 900 and UE transmitter 904 may be collectively referred to as a transceiver. The transceiver may transmit and receive signals to and from the base station. The signal may include control information and data. To this end, the transceiver may include an RF transmitter for up-converting and amplifying a frequency of a signal being transmitted, and an RF receiver for low-noise-amplifying a received signal and down-converting a frequency of the received signal, Also, the transceiver may receive a signal through a radio channel, output the signal to the UE processor 902, and transmit a signal output from the UE processor 902 through a radio channel. The UE processor 902 may control a series of operations to allow the UE to operate according to the above-described embodiments.

FIG. 10 illustrates an internal structure of a base station according to an embodiment.

Referring to FIG. 10, the base station may include a base station receiver 1001, a base station transmitter 1005, and a base station processor 1003. The base station receiver 1001 and base station transmitter 1005 may be collectively referred to as a transceiver. The transceiver may transmit and receive signals to and from a UE. The signal may include control information and data. To this end, the transceiver may include an RF transmitter for up-converting and amplifying a frequency of a signal being transmitted, and an RF receiver for low-noise-amplifying a received signal and down-converting a frequency of the received signal. The transceiver may receive a signal through a radio channel, output the signal to the base station processor 1003, and transmit a signal output from the base station processor 1003 through a radio channel. The base station processor 1003 may control a series of operations to allow the base station to operate according to the above-described embodiments.

Each block of process flowcharts and combinations of the flowcharts may be performed by computer program instructions. Because these computer program instructions may be embedded in a processor of a general-purpose computer, a special-purpose computer, or other programmable data processing apparatuses, the instructions executed through the processor of the computer or other programmable data processing apparatus generates modules for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the functions involved therein.

The term unit, as used in the present embodiment of the disclosure refers to a software or hardware component, such as field-programmable gate array (FPGA) or application-specific integrated circuit (ASIC), which performs certain tasks. However, the term unit is not limited to software or hardware. The term unit may be configured in an addressable storage medium or may be configured to reproduce one or more processors. Therefore, for example, the term unit includes elements, such as software elements, object-oriented software elements, class elements, and task elements, processes, functions, attributes, procedures, subroutines, segments of program code, drivers, firmware, microcodes, circuits, data, databases, data structures, tables, arrays, and variables. Functions provided in the elements and the units may be combined with fewer elements and units, or may be separated from additional elements and units. Furthermore, the elements and the units may be implemented to reproduce one or more central processing units (CPUs) in the device or secure multimedia card. In addition, the unit may include one or more processors in embodiments.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a first user equipment (UE) in a wireless communication system, the method comprising:
receiving, from a location management function (LMF), assistance data including an ultra-wideband (UWB) anchor list;
receiving, from a plurality of UWB anchors, a plurality of UWB messages including UWB measurements;
determining location information of the first UE based on the plurality of UWB messages; and
transmitting, to the LMF, the determined location information.

2. The method of claim 1, further comprising:
transmitting, to the LMF, capability information associated with an ability to receive a UWB signal.

3. The method of claim 1, further comprising:
transmitting, to a second UE using a sidelink positioning protocol (SLPP), the plurality of UWB messages.

4. The method of claim 3,
wherein the second UE is in a shadow area with respect to the plurality of UWB anchors.

5. The method of claim 1,
wherein the plurality of UWB messages is received in response to a UWB message from an initiator UWB anchor.

6. The method of claim 1,
wherein at least one of the plurality of UWB anchors is included in a base station.

7. A method performed by a second user equipment (UE) in a wireless communication system, the method comprising:
transmitting, to a first UE using a sidelink positioning protocol (SLPP), a request message for ultra-wideband (UWB) information; and
receiving, from the first UE, a plurality of UWB messages including UWB measurements,
wherein the plurality of UWB messages is obtained by the first UE from a plurality of UWB anchors.

8. The method of claim 7,
wherein the second UE is in a shadow area with respect to the plurality of UWB anchors.

9. A first user equipment (UE) in a wireless communication system, the first UE comprising:
a transceiver; and
a controller coupled with the transceiver and configured to:
receive, from a location management function (LMF), assistance data including an ultra-wideband (UWB) anchor list,
receive, from a plurality of UWB anchors, a plurality of UWB messages including UWB measurements,
determine location information of the first UE based on the plurality of UWB messages, and
transmit, to the LMF, the determined location information.

10. The first UE of claim 9,
wherein the controller is further configured to:
transmit, to the LMF, capability information associated with an ability to receive a UWB signal.

11. The first UE of claim 9,
wherein the controller is further configured to:
transmit, to a second UE using a sidelink positioning protocol (SLPP), the plurality of UWB messages,
wherein the second UE is in a shadow area with respect to the plurality of UWB anchors.

12. The first UE of claim 9,
wherein the plurality of UWB messages is received in response to a UWB message from an initiator UWB anchor.

13. The first UE of claim 9,
wherein at least one of the plurality of UWB anchors is included in a base station.

14. A second user equipment (UE) in a wireless communication system, the second UE comprising:
a transceiver; and
a controller coupled with the transceiver and configured to:
transmit, to a first UE using a sidelink positioning protocol (SLPP), a request message for ultra-wideband (UWB) information, and
receive, from the first UE, a plurality of UWB messages including UWB measurements,
wherein the plurality of UWB messages is obtained by the first UE from a plurality of UWB anchors.

15. The second UE of claim 14,
wherein the second UE is in a shadow area with respect to the plurality of UWB anchors.
